(19) United States
(12) Patent Application Publication
(10) Pub. No.: US 2009/0302559 A1
(43) Pub. Date: Dec. 10, 2009

(54) Spring Assembly With an Adjustable Spring Rate and a Spring Strut

(75) Inventor: Daniel Prieto DOERFEL, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/540,898

(22) Filed: Aug. 13, 2009

Related U.S. Application Data
(63) Continuation of application No. PCT/EP2008/001941, filed on Mar. 12, 2008.

(30) Foreign Application Priority Data
Apr. 2, 2007 (DE) 10 2007 015 888.4

(51) Int. Cl. B60G 17/018; B60G 15/00

(52) U.S. Cl. 280/5.519; 267/225

(57) ABSTRACT

A spring assembly has a master spring, a slide, a stop and at least one auxiliary spring connected in series with the master spring. The auxiliary spring has a first end to which the stop is fastened, and a second end facing away from the first end, with respect to which the slide can be fastened. The position of the slide is adjustable such that, when, during the compression of the spring assembly, the auxiliary spring has overcome a predetermined compression path, the stop strikes against the slide, and a further compression of the auxiliary spring is thereby prevented. A spring strut for a motor vehicle has the spring assembly. An alternative spring assembly arranges the auxiliary spring parallel to the master spring with a first end in the compression direction of the spring assembly being freely displaceable. The position of the slide is adjustable such that when, during the compression of the spring assembly, the first end has overcome a predetermined compression path, the stop strikes against the slide and, as a result, the auxiliary spring is connected parallel to the master spring.

### CROSS-REFERENCE TO RELATED APPLICATIONS

This application is a continuation of PCT International Application No. PCT/EP2008/001941, filed Mar. 12, 2008, which claims priority under 35 U.S.C. § 119 to German Patent Application No. DE 10 2007 015 888.4, filed Apr. 2, 2007, the entire disclosures of which are herein expressly incorporated by reference.

### BACKGROUND AND SUMMARY OF THE INVENTION

This invention relates to a spring assembly with a variable spring rate and a spring strut equipped to be suitable for a motor vehicle that includes the spring assembly.

In vehicle engineering, it is known to suspend a wheel of a vehicle on the vehicle body by use of a spring strut. The spring strut has a coil spring and a hydraulic shock absorber, which is arranged within the coil spring. The coil spring and the shock absorber are connected in parallel to one another so that, when it changes its length, the spring strut has an elastic as well as a damping characteristic. The wheel with its axle is fastened to one end of the spring strut, and the other end of the spring strut is fastened to the vehicle body, so that the vehicle body is suspended by the spring strut.

On the one hand, the yielding of the spring strut depends on the shocks introduced into the spring strut via the wheel during the drive of the vehicle and, on the other hand, on the weight of the vehicle body and its useful load, respectively. The yielding manner of the spring strut and thus the suspension characteristic of the vehicle body are determined particularly by the spring rate of the coil spring. When the coil spring of the spring strut has a high spring rate, the cushioning of the vehicle body will be hard, whereas the cushioning of the vehicle body will be soft when the coil spring of the spring strut has a low spring rate.

Because of the different conditions under which the vehicle is driven, particularly varying unevenness of the ground, and which are to be compensated by the spring strut, and because of the different degrees of loading of the vehicle body, it is desirable for the spring strut to be adaptable. In particular, it is desirable for the spring rate of the spring strut to be variable, so that the type of suspension of the vehicle body can be adjusted as a function of the driving conditions.

Thus, a soft suspension of the vehicle body would be preferable when the useful load is light and the roadway is even while the driving is slow, whereas a hard suspension of the vehicle body would be preferable when the useful load is heavy and the roadway is uneven while the driving is fast.

Spring systems are known which have several springs and, in the case of which, the transmission of force and movement takes place by way of hydraulic conduits. During the compression of the arrangement, hydraulic oil will flow in certain switching states. The springs are connected in series and/or parallel to one another and can be optionally activated or deactivated. The activating and the deactivating of selected springs can be carried out by way of actuators and/or valves.

This has the result that high flow velocities occur in hydraulic components, such as valves and conduits, provided, for example, for the spring strut, which flow velocities may lead to increased wear, development of noise, and increased generation of heat.

It is an object of the invention to provide a spring assembly and a spring strut having this spring assembly whose spring rate can be adjusted in a simple, fast and precise manner.

The spring assembly according to the invention has a master spring, a slide, a stop and at least one auxiliary spring connected in series with the master spring and having a first end, to which the stop is fastened, and a second end facing away from the first end with respect to which the slide can be fastened. The position of the slide is adjustable such that, during the compression of the spring assembly, when the auxiliary spring has overcome a predetermined compression path, the stop strikes against the slide, and a further compression of the auxiliary spring is thereby prevented.

When the spring assembly is not loaded, it is completely extended. When the spring assembly is compressed, the master spring as well as the auxiliary spring will be shortened. The spring rate of the spring assembly is the result of the series connection of the master spring and the auxiliary spring. When the spring assembly is compressed further and when the actual compression path of the auxiliary spring reaches the predetermined compression path, the stop will strike against the slide. As a result, a further shortening of the auxiliary spring is prevented when the spring assembly is subjected to a further compression. As soon as the stop strikes against the slide, the auxiliary spring will no longer have a spring effect, so that the spring rate of the spring assembly will be determined by the master spring.

As a result, it is achieved that, until the stop strikes against the slide, the spring rate of the spring assembly is determined by the master spring as well as the auxiliary spring, whereas after the striking of the stop against the slide, the spring rate of the spring assembly will be determined only by the master spring. Because of the fact that the master spring and the auxiliary spring are connected in series, the spring rate of the spring assembly is lower before the stop strikes against the slide than afterwards. This has the result that, in the case of short compression paths, the spring rate of the spring assembly is lower than in the case of long compression paths, where the predetermined compression path of the auxiliary spring is exceeded.

The spring strut for a motor vehicle according to the invention includes the inventive spring assembly.

The spring strut therefore has such a spring characteristic that, in the case of short compression paths, the cushioning of the motor vehicle is soft, whereas, in the case of long compression paths, where the actual compression path of the auxiliary spring has reached the predetermined compression path, the cushioning of the motor vehicle is hard. As a result, the motor vehicle in which the spring strut is provided has a high driving comfort. In addition, the probability is reduced that, when driving over very uneven road sections, the motor vehicle will undesirably be lowered, whereby the safety of the motor vehicle is increased.

The predetermined compression path of the auxiliary spring can be set by adjusting the position of the slide. As a result, it becomes possible for the switching point of the spring assembly and of the spring strut to be adjusted in a variable manner. Thus, the position of the slide can, for example, be defined such that the stop strikes against the slide when the spring assembly is still extended in a manner as good as unloaded. As a result, the spring rate of the spring assembly is determined only by the master spring, whereby the spring strut provides a hard cushioning for the motor vehicle over the entire compression range.

Further, the position of the slide may be set such that, when the spring assembly is completely compressed, the stop will only then strike against the slide.

As a result, it is achieved that, during the entire compression of the spring assembly, its spring rate is determined by the master spring together with the auxiliary spring, whereby the spring strut provides the motor vehicle with a soft cushioning. Thus, the spring rate of the spring assembly can be varied over a large range by the positioning adjustment of the slide.

It is preferable for the spring assembly to have a hydraulic chamber and to have the slide as a hydraulic piston arranged in the hydraulic chamber, which hydraulic piston can be displaced away from the second end by a hydraulic fluid, when the latter is introduced into the hydraulic chamber, so that the predetermined compression path is shortened. By way of the hydraulic fluid, when the latter is discharged from the hydraulic chamber, the hydraulic piston can be displaced toward the second end, so that the predetermined compression path is extended. And, when the hydraulic chamber is tightly closed off, the hydraulic piston is supported at the second end without a change of position.

It is further preferable for the hydraulic piston to be displaceable by the stop into the hydraulic chamber when the stop exercises a corresponding force upon the hydraulic piston.

The slide, in the form of the hydraulic piston, can thereby be continuously displaced and can be held in any position by way of the hydraulic fluid. The adjustability of the spring assembly will therefore be flexible and versatile.

The spring assembly preferably has a hydraulic fluid reservoir and a hydraulic conduit, which connects the hydraulic fluid reservoir with a hydraulic chamber in a hydraulic-fluid-conducting manner. A switching arrangement is provided having a check valve with a blocking effect in the direction from the hydraulic chamber to the hydraulic fluid reservoir, and a check valve with a blocking direction from the hydraulic fluid reservoir to the hydraulic chamber, as well as a shut-off device. The check valves and the shut-off device are optionally switchable into the hydraulic conduit.

When the check valve with the blocking direction from the hydraulic chamber to the hydraulic fluid reservoir is switched into the hydraulic conduit, the hydraulic piston can be pressed in the direction of the second end by way of the hydraulic fluid. In this case, the auxiliary spring, as well as the master spring, is compressed during the compression of the spring assembly, causing the spring assembly to have a low spring rate. Since the hydraulic fluid flows out of the hydraulic fluid reservoir, the pressure in the hydraulic fluid reservoir will rise.

When the check valve with the blocking direction from the hydraulic fluid reservoir to the hydraulic chamber is switched into the hydraulic conduit, the hydraulic piston can follow the stop during the rebounding of the spring assembly. When high pressure exists in the hydraulic fluid reservoir, this high pressure causes the moving-out of the hydraulic piston. In contrast, the discharge of the hydraulic fluid from the hydraulic chamber is blocked during the compression of the spring assembly, so that only the master spring can be compressed when the predetermined compression path of the auxiliary spring has been reached, causing the spring rate of the spring assembly to be high.

When, in contrast, the discharge of the hydraulic fluid from the hydraulic chamber is shut-off by means of the shut-off device, the actual position of the hydraulic piston will determine the predetermined compression path of the auxiliary spring. For detecting the predetermined compression path of the auxiliary spring, the position of the hydraulic piston should be determined. This can take place either directly at the piston, or directly or indirectly by way of the hydraulic fluid reservoir, particularly by detecting the pressure in the hydraulic fluid reservoir.

In addition, it is preferable for the hydraulic fluid to be delivered from the hydraulic fluid reservoir by a delivery device, whereby the hydraulic piston can additionally be moved out by more than the length of the auxiliary spring. The spring assembly is thereby additionally lengthened. This is advantageous because the motor vehicle suspended by the spring strut can be raised. In this case, only the master spring can be compressed, so that the spring assembly has a high spring rate. The auxiliary spring should preferably be fixed at its first and its second end, so that it cannot move out of its position in an unintended manner by contraction.

As an alternative, it is preferable for the spring assembly to have a hydraulic conduit and a hydraulic fluid reservoir which, in a hydraulic-fluid-conducting manner, is connected with the hydraulic chamber via the hydraulic conduit and which has an adjusting piston and an adjusting piston drive, by which the adjusting piston can be displaced such that the hydraulic fluid can be introduced into the hydraulic chamber by the adjusting piston.

As a result, by operating the adjusting piston drive, the hydraulic piston can be displaced away from the second end of the auxiliary spring and can thereby be changed in its position. This displacement of the hydraulic piston can also take place against the resistance of the master spring via the stop. The adjusting piston drive preferably is a manual drive or a servo motor having a spindle or an eccentric.

Preferably, the adjusting piston is freely displaceably arranged in the hydraulic fluid reservoir and the adjusting piston drive is constructed as a displaceable adjusting piston stop, which limits the movement of the adjusting piston when the hydraulic fluid is discharged from the hydraulic chamber, and can displace the adjusting piston such that the hydraulic fluid can be introduced into the hydraulic chamber.

When, during the compression of the spring strut, the stop strikes against the hydraulic piston, the latter is moved in the direction of the first end by the stop so that the hydraulic fluid exits from the hydraulic chamber and is transported into the hydraulic fluid reservoir, whereby the adjusting piston is correspondingly displaced. The displacement of the adjusting piston is limited by the position of the adjusting piston stop.

Because of the fact that the adjusting piston stop can be displaced, the end position of the adjusting piston and thereby the end position of the hydraulic piston can be defined by means of the adjusting piston. When the adjusting piston stop is moved toward the front from the end position by way of the adjusting piston drive when the adjusting piston rests against the adjusting piston stop, via the adjusting piston, the hydraulic fluid will be pressed out of the hydraulic fluid reservoir back into the hydraulic chamber, whereby the hydraulic piston moves away from the second end of the auxiliary spring.

Preferably, the first end of the auxiliary spring faces the master spring and the second end of the auxiliary spring faces away from the master spring.

Furthermore, it is preferable for the spring assembly to have an intermediate piece on which the stop is constructed. The intermediate piece has a first shoulder, on which the auxiliary spring is supported with its second end, and a second shoulder on which the master spring is supported.

In addition, it is preferable for the spring assembly to have a hydraulic cylinder which forms the hydraulic chamber and is supported relative to the second end of the auxiliary spring.

It is preferable for the spring assembly to have several auxiliary springs, which are connected in series or parallel with the master spring. As a result, the spring rate of the spring assembly can preferably be adjusted by a corresponding actuation of the stops of the auxiliary springs.

An alternative spring assembly according to the invention has a master spring, a slide, a stop and at least one auxiliary spring, which is arranged parallel to the master spring. A first free end of the auxiliary spring is displaceable in the compression direction of the spring assembly and to which the stop is fastened, and a second end facing away from the first end is provided with respect to which the slide can be fastened whose position can be adjusted such that when, during the compression of the spring assembly, the first end has overcome a predetermined compression path, the stop strikes against the slide and, as a result, the auxiliary spring is connected parallel to the master spring.

The alternative spring assembly preferably has a hydraulic chamber and the slide as a hydraulic piston arranged in the hydraulic chamber, which hydraulic piston can be displaced toward the second end by a hydraulic fluid, when the latter is introduced into the hydraulic chamber, so that the predetermined compression path is shortened, and which, by way of the hydraulic fluid, when the latter is discharged from the hydraulic chamber, can be displaced away from the second end, so that the predetermined compression path is extended. By way of the hydraulic fluid, when the hydraulic chamber is tightly closed off, the hydraulic piston is supported at the second end without a change of position.

Furthermore, the alternative spring assembly preferably has an intermediate piece on which the stop is constructed and which has a first shoulder on which the auxiliary spring is supported by means of its first end.

In addition, the intermediate piece preferably has a contact pressure spring and a second shoulder on which the contact pressure spring is supported, so that the intermediate piece is fastened to the first end.

All of above-mentioned preferred further developments of the invention and their advantageous effects should also be considered to be disclosed in connection with the alternative spring assembly.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a longitudinal sectional view of a first embodiment of the spring strut according to the invention, the spring strut being in a first operating condition;

FIG. 2 is a longitudinal sectional view of the first embodiment of the spring strut according to the invention in a second operating condition;

FIG. 3 is a longitudinal sectional view of the first embodiment of the spring strut according to the invention in a third operating condition;

FIG. 4, is a view of a hydraulic device of the spring strut according to the invention in a first operating position;

FIG. 5 is a view of the hydraulic device of the spring strut according to the invention in a second operating position;

FIG. 6 is a view of the hydraulic device of the spring strut according to the invention in a third operating position;

FIG. 7 is a view of an alternative hydraulic device of the spring strut according to the invention;

FIG. 8 is a longitudinal sectional view of a second embodiment of the spring strut according to the invention in a first operating condition;

FIG. 9 is a longitudinal sectional view of the second embodiment of the spring strut according to the invention in a second operating condition;

FIG. 10 is a longitudinal sectional view of the second embodiment of the spring strut according to the invention in a third operating condition;

FIG. 11 is a longitudinal sectional view of the second embodiment of the spring strut according to the invention in a fourth operating condition; and

FIG. 12 is a longitudinal sectional view of the second embodiment of the spring strut according to the invention in a fifth operating condition.

### DETAILED DESCRIPTION OF THE DRAWINGS

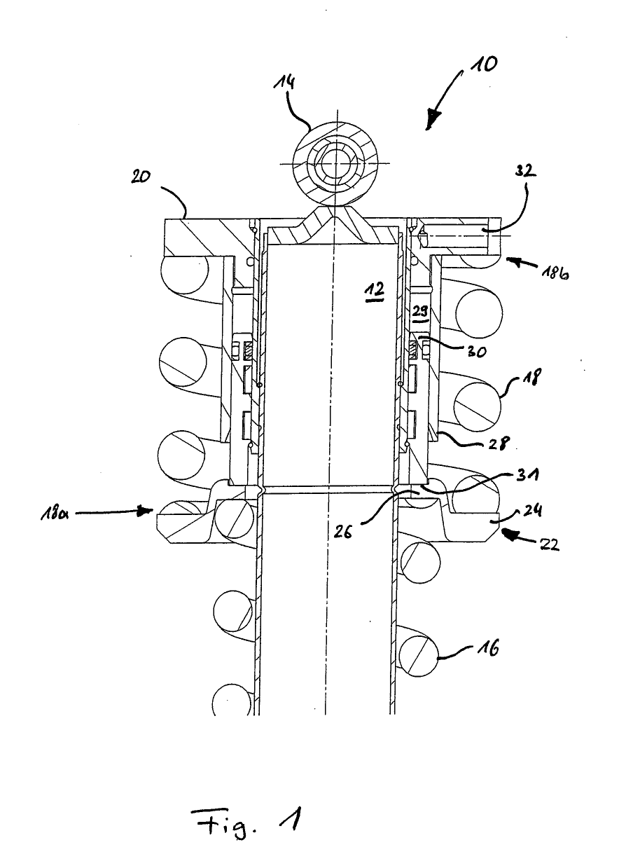

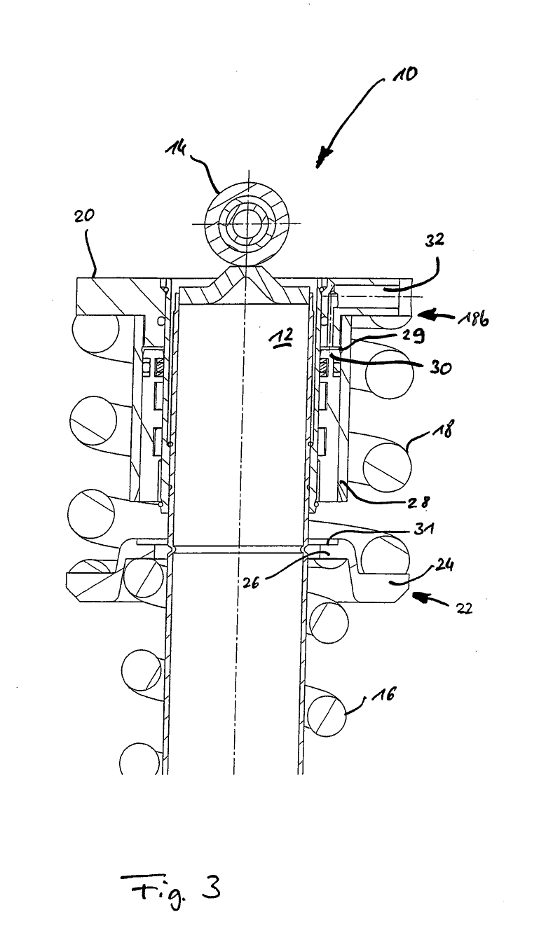

As illustrated in FIGS. 1 to 7, a spring strut 10 has a shock absorber 12. A bearing lug 14 is provided at the shock absorber 12, on which a body of a motor vehicle (not shown) can be suspended. The spring strut 10 further has a master spring 16 and an auxiliary spring 18.

The master spring 16 is connected in series with the auxiliary spring 18, which has a first end 18a facing the master spring 16, and a second end 18b facing away from the master spring 16. The master spring 16 has a rotationally symmetrical construction, and the auxiliary spring 18 is constructed as a coil spring, the master spring 16 and the auxiliary spring 18 being situated on a common axis together with the shock absorber.

An auxiliary spring base 20, on which the second end 18b of the auxiliary spring 18 is supported, is fastened to the shock absorber 12. Furthermore, the spring strut 10 has an intermediate piece 22, which is situated between the master spring 16 and the auxiliary spring 18. The intermediate piece 22 has a first shoulder 24 which is arranged to be facing the auxiliary spring base 20 and on which the second end 18b of the auxiliary spring 18 is supported. In addition, the intermediate piece 22 has a second shoulder 26 on which the master spring 16 is supported.

The auxiliary spring 18 has a radial dimension which is greater than that of the master spring 16. The first shoulder 24 and the second shoulder 26 of the intermediate piece 22 are arranged to be offset in the direction of the common axis, so that the master spring 16 is arranged inside (or reaches behind) the first end 18a of the auxiliary spring 18. A hydraulic cylinder 28 is provided, which is supported on the auxiliary spring base 20 and defines an annular hydraulic chamber 29. A hydraulic piston 30, which can be displaced along the common axis, is arranged in the hydraulic cylinder 28.

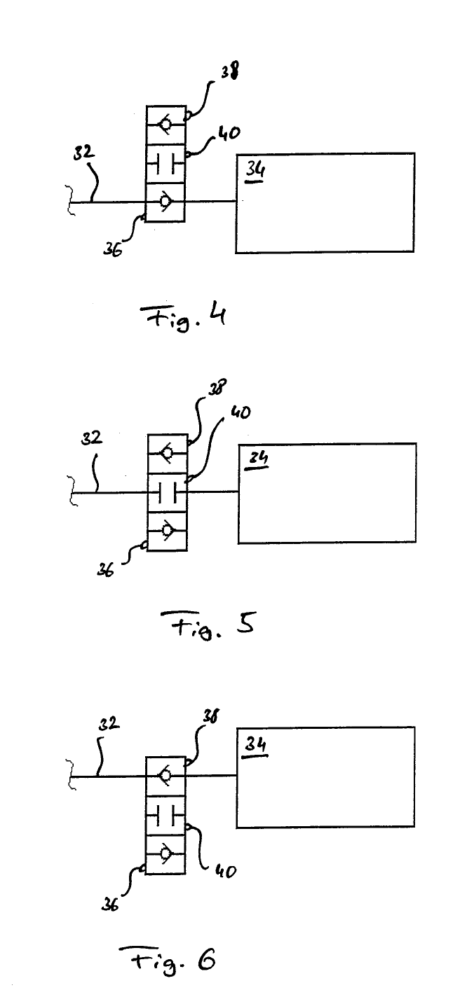

Furthermore, as can be seen in FIGS. 4-7, the spring strut 10 has a hydraulic fluid reservoir 34 and a hydraulic conduit 32, which connects the hydraulic chamber 29 and the hydraulic fluid reservoir 34 with one another in a fluid-conducting manner. The hydraulic chamber 29, the hydraulic conduit 32, and the hydraulic fluid reservoir 34 are filled with a hydraulic fluid.

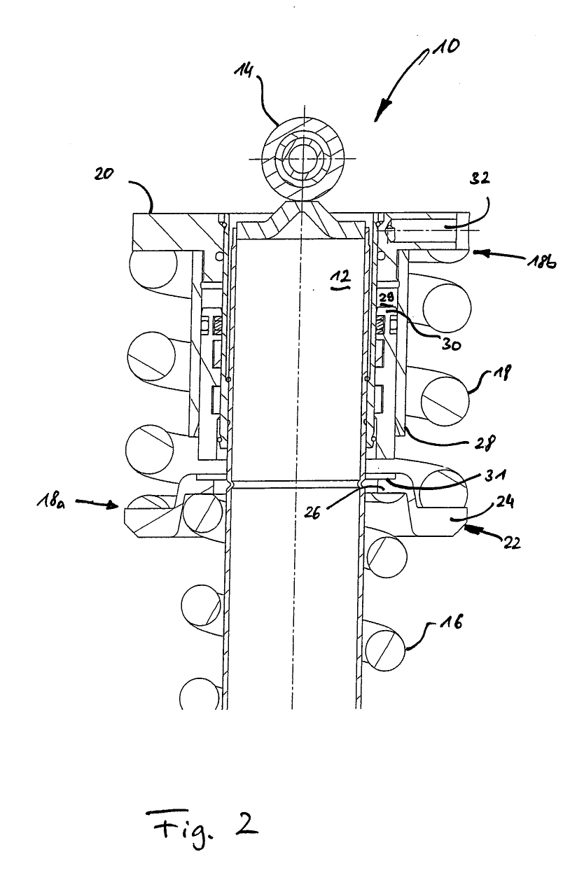

The intermediate piece 22 has a stop 31 which extends from the master spring 16 in the direction of the second end 18b of the auxiliary spring 18. In the displaceability direction of the hydraulic piston 30, the stop 31 is arranged in alignment with the latter. As illustrated in FIGS. 1 and 2, the stop 31 has a free end which strikes against the hydraulic piston 30.

The first embodiment of the spring strut 10 illustrated in FIG. 1 has a first check valve 36, a second check valve 38, and a shut-off device 40 in the hydraulic conduit (see FIG. 4). The first check valve 36 as well as the second check valve 38 and the shut-off device 40 can optionally be switched into the hydraulic conduit 32.

The first check valve 36 has a flow-through direction pointing from the hydraulic fluid reservoir 34 to the hydraulic chamber 29. The second check valve 38 has a flow-through direction pointing from the hydraulic chamber 29 to the hydraulic fluid reservoir 34.

As illustrated in FIG. 4, the first check valve 36 is switched into the hydraulic conduit 32. As a result, the hydraulic fluid, which is situated in the hydraulic fluid reservoir 34, can flow into the hydraulic chamber 29 while passing through the first check valve 36. This is particularly so when the pressure of the hydraulic fluid in the hydraulic fluid reservoir 34 is higher than the pressure of the hydraulic fluid in the hydraulic chamber 29. During the rebounding of the spring strut 10, the hydraulic piston 30 can therefore follow the intermediate piece 22. In contrast, during the compression of the spring strut 10, the first check valve 36 is blocked, so that the discharge of the hydraulic fluid from the hydraulic chamber 29 is prevented, with the effect that the hydraulic piston 30 remains in its position. This is the “hard spring” switching.

When the second check valve 38 is switched into the hydraulic conduit 32 (see FIG. 6), the hydraulic piston 30 can be pressed into the hydraulic cylinder 28 by the stop 31. This is the “soft spring” switching. In this case, hydraulic fluid flows into the hydraulic reservoir 34, whereby the pressure in the hydraulic fluid reservoir 34 is increased.

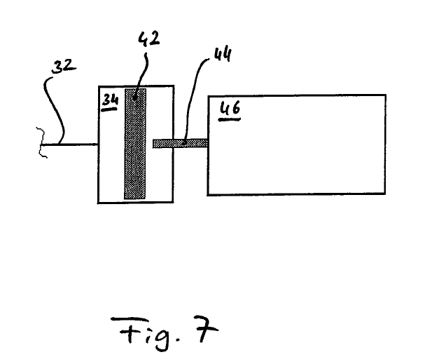

When the shut-off device 40 is switched into the hydraulic conduit 32 (see FIG. 5), the flow of the hydraulic fluid through the hydraulic conduit 32 is blocked, thereby causing the change of the spring characteristic from “soft spring” to “hard spring”.

The spring strut 10 according to FIGS. 1 to 4 and 7 has a freely displaceable adjusting piston 42 in the hydraulic fluid reservoir 34 and an adjusting piston stop 44 arranged in the hydraulic fluid reservoir 34, which adjusting piston stop 44 is driven by an adjusting piston drive 46.

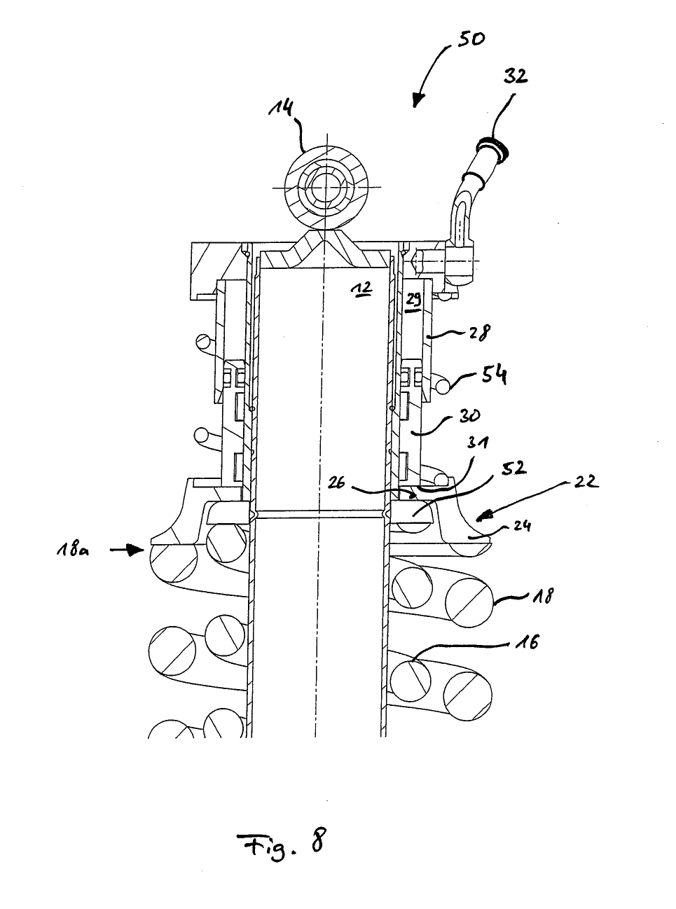

When the adjusting piston 42 is pressed from the right to the left as illustrated in FIG. 7 by the adjusting piston stop 44 and the adjusting piston drive 46, the hydraulic fluid situated in the hydraulic fluid reservoir 34 is introduced through the hydraulic conduit 32 into the hydraulic chamber 29. As a result, the hydraulic piston 30 is pressed downward, as illustrated in FIG. 2, against the stop 31. During the rebounding of the spring strut 10, the hydraulic piston 30 can follow the stop 31.

When the adjusting piston stop 44 is withdrawn by the adjusting piston drive 46, so that a distance occurs between the adjusting piston 42 and the adjusting piston stop 44, the adjusting piston 42 will be freely displaceable in the direction of the adjusting piston stop 44 in the hydraulic piston reservoir 34. When, during the compression of the spring strut 10, the hydraulic piston 30 is pressed into the hydraulic cylinder 28 by the stop 31, the hydraulic fluid is transported from the hydraulic chamber 29 through the hydraulic conduit 32 into the hydraulic fluid reservoir 34. In this case, the adjusting piston 42 moves to the right in FIG. 2 analogous to the hydraulic piston 30, until the adjusting piston 42 strikes against the adjusting piston stop 44. As result, the moving range of the adjusting piston 42 as well as of the hydraulic piston 30 is limited by way of the adjusting piston stop 44.

The adjusting piston drive 46 is arranged such that the adjusting piston stop 44 can be moved into a first end position and into a second end position. In the first end position, the adjusting piston stop 44 extends less into the hydraulic fluid reservoir 34 than in the second end position.

When the adjusting piston stop 44 is in the first end position, the spring strut 10 has a soft characteristic spring curve because the master spring 16 as well as the auxiliary spring 18 is pressed in during the compression.

When, by adjusting the piston drive 46, the adjusting piston 42 is moved from the first end position in the direction of the second end position, the hydraulic piston 30 will move analogous to the adjusting piston 42 away from the second end 18b of the auxiliary spring 18. During the compression, the spring strut 10 therefore will have a soft characteristic spring curve until the stop 31 strikes against the hydraulic piston 30. During the further compression, the strut will then have a hard characteristic spring curve.

When the adjusting piston stop 44 is moved farther from the first end position in the direction of the second end position by the adjusting piston drive 46, the hydraulic piston 30 will move farther away from the second end 18b of the auxiliary spring 18 in an analogous manner. In this case, the intermediate piece 22 is displaced by the hydraulic piston 30 in the direction away from the second end 18b of the auxiliary spring 18. The hydraulic piston 30 thereby finally reaches a position in which the distance between the auxiliary spring base 20 and the second shoulder 26 of the intermediate piece 22 corresponds to the length which the auxiliary spring 18 has in its unloaded condition. In this case, during the compression of the spring strut 10, the auxiliary spring 18 can no longer be compressed, so that, during the compression of the spring strut 10, only the master spring 16 is compressed. As a result, the spring strut 10 has a hard characteristic spring curve.

When, as illustrated in FIG. 2, the adjusting piston 42 is moved farther to the left by the adjusting piston stop 44 which is driven by the adjusting piston drive 46, the hydraulic fluid continues to be pressed out of the hydraulic fluid reservoir 34 through the hydraulic conduit 32 into the hydraulic chamber 29. The hydraulic piston 30 is thereby moved farther away from the second end 18b of the auxiliary spring 18, whereby the intermediate piece is displaced farther in this direction. The master spring 16 is thereby compressed, whereby its prestressing is increased. The characteristic spring curve of the spring strut 10 is therefore hard, in which case the vehicle is raised.

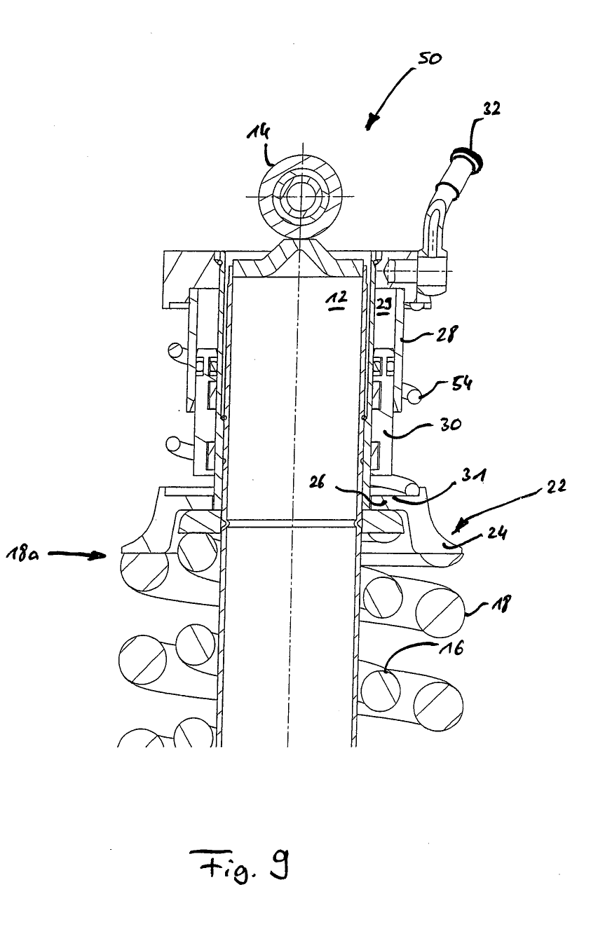

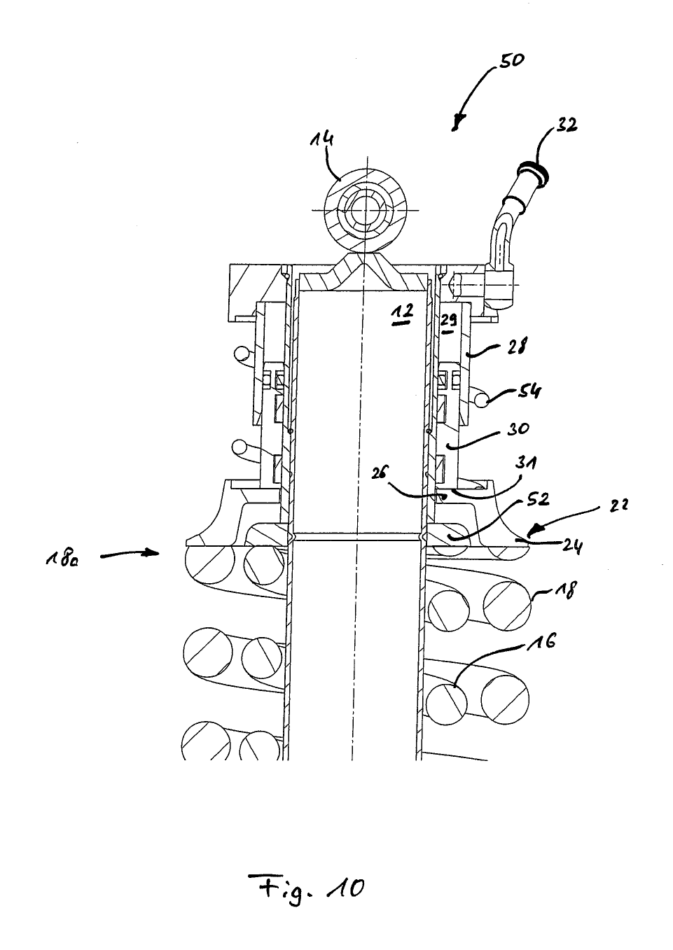

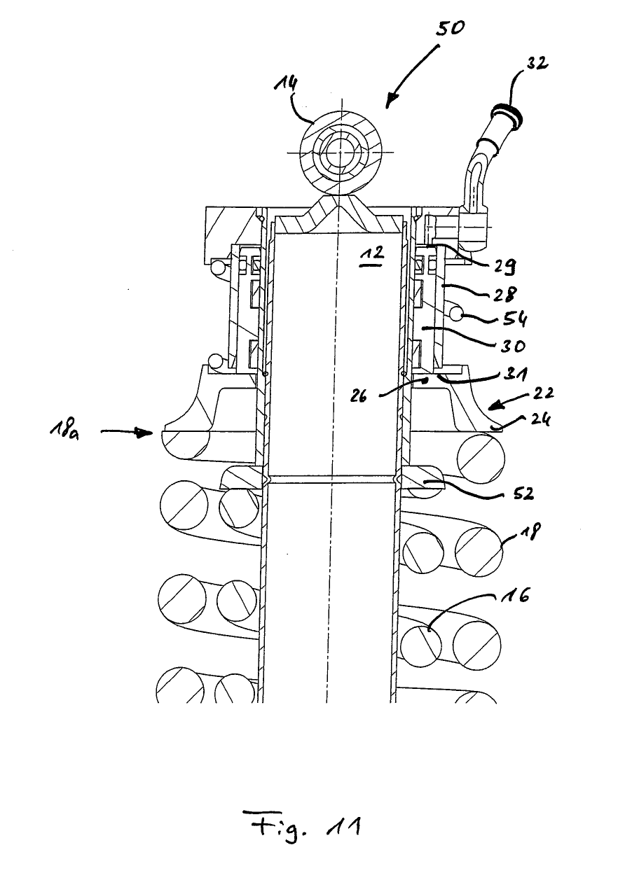

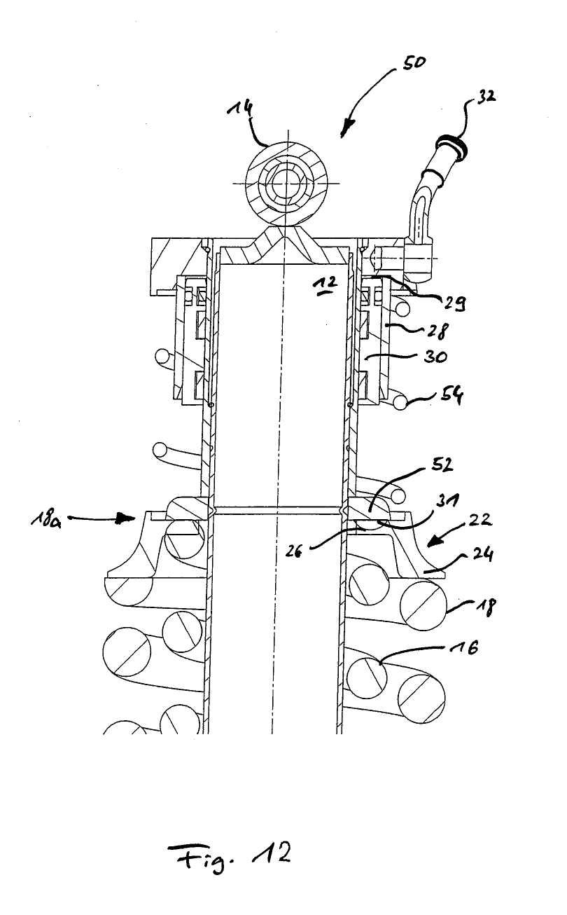

As illustrated in FIGS. 8 to 12, a second embodiment of a spring strut 50 has reference parts corresponding with parts of the spring strut 10 according to FIGS. 1 to 3. The identically named parts are comparable.

The spring strut 50 has the master spring 16 and the auxiliary spring 18 which are connected parallel to one another. The master spring 16 is concentrically arranged inside the auxiliary spring 18. The spring strut 50 has a master spring base 52, which is stationarily fastened to the shock absorber 12 and on which the master spring base 16 is fixedly supported with its one end. By way of the master spring base 52, the master spring 16 is connected in the spring strut 50 such that the master spring 16 is correspondingly compressed in the case of all spring movements of the spring strut 50 and has a cushioning effect.

The first end 18a of the auxiliary spring 18 is supported on the first shoulder 24 of the intermediate piece 22. The stop 31, which is provided on the second shoulder 26, is situated on the side of the intermediate piece 22 facing away from the auxiliary spring 18.

The hydraulic piston 30 can be placed against the stop 31 when the hydraulic piston 30 is moved into the corresponding position relative to the intermediate piece 22. Furthermore, the intermediate piece 22 can be supported by the second shoulder 26 on the master spring base 52 in the longitudinal direction of the shock absorber 12. The intermediate piece 22 can be displaced parallel to the longitudinal direction of the shock absorber 12 and, viewed in the longitudinal direction of the shock absorber 12, is arranged between he hydraulic piston 30 and the master spring base 52, so that the hydraulic piston 30 limits a displacement of the intermediate piece 22 in one direction, and the master spring base 52 limits a displacement of the intermediate piece 22 in the other direction.

According to FIG. 8, the hydraulic piston 30 is arranged such that the intermediate piece 22 is clamped between the hydraulic piston 30 and the master spring base 52. As a result, the master spring 16 and the auxiliary spring 18 are connected parallel to one another, so that, during the compression of the spring strut 50, the master spring 16 as well as the auxiliary spring 18 yields and the spring strut 50 has a stiff spring characteristic.

When the hydraulic piston 30 is lifted off the intermediate piece 22 or off the stop 30, as illustrated in FIG. 9, the intermediate piece 22 can be displaced in the direction of the hydraulic piston 30 in the longitudinal direction of the shock absorber 12. When the spring strut 50 compresses, the master spring 16 is compressed, whereas the auxiliary spring 18 remains in its original length because the first end 18a of the auxiliary spring 18 with the intermediate piece 22 can be displaced in the direction of the hydraulic piston 30.

When, during a further compression of the spring strut 50, the stop 31 finally reaches the hydraulic piston 30, the intermediate piece 22 will rest against the hydraulic piston 30. As a result, the auxiliary spring 18 is supported at its first end 18a via the first shoulder 24 and the stop 31 on the hydraulic piston 30. During a further compression of the spring strut 50, the master spring 16 as well as the auxiliary spring 18 is thereby compressed, so that the spring characteristic of the spring strut 50 will change from soft to hard.

By means of the effect of the spring force of the auxiliary spring 18 upon the hydraulic piston 30, the hydraulic piston 30 can be moved within the hydraulic cylinder 28, as described above with respect to FIGS. 1 to 6. Likewise, as described for FIGS. 1 to 6, the auxiliary piece 22 can be correspondingly moved by means of the hydraulic cylinder 30.

The spring strut 50 has a contact pressure spring 54, which is supported on the auxiliary piece 22 and presses the latter in the direction of the auxiliary spring 18. As a result, it is achieved that, in each operating condition of the spring strut 50, the intermediate piece 22 rests with the first shoulder 24 against the first end 18a of the auxiliary spring 18. It is thereby prevented that the first end 18a of the auxiliary spring 18 lifts off the shoulder 24 of the intermediate piece 22 and thereby causes a noise, such as a clattering or rattling.

According to FIG. 12, the spring strut 50 is exposed to a tensile loading. In this case, the master spring 16 is pulled apart. The spring strut 50 is arranged such that the auxiliary spring 18 is not pulled apart under the tensile loading. This is achieved in that the intermediate piece 22 is designed such that it can be displaced beyond the master spring base 52. As a result, the intermediate piece 22 is moved by the contact pressure spring 54 beyond the master spring base 52, in which case the intermediate piece 22 is pressed against the first end 18a of the auxiliary spring 18 and thus is caused to follow the first end 18 when the master spring 16 is pulled apart.

### TABLE OF REFERENCE NUMBERS

10 Spring strut (series arrangement)
12 Shock absorber
14 Bearing lug
16 Master spring
18 Auxiliary spring
18a First end
18b Second end
20 Auxiliary spring base
22 Intermediate piece
24 First shoulder
26 Second shoulder
28 Hydraulic cylinder
29 Hydraulic chamber
30 Hydraulic piston (slide)
31 Stop
32 Hydraulic conduit
34 Hydraulic fluid reservoir
36 First check valve
38 Second check valve
40 Shut-off device
42 Adjusting piston
44 Adjusting piston stop
46 Adjusting piston drive
50 Spring strut (parallel arrangement)
52 Master spring base
54 Contact pressure spring

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A spring assembly, comprising:
a master spring;
a slide;
a stop;
at least one auxiliary spring connected in series with the master spring, the auxiliary spring having a first end to which the stop is attached and a second end, facing away from the first end, to which the slide is settable;
wherein a position of the slide is adjustable such that, during the compression of the spring assembly, when the auxiliary spring overcomes a predetermined compression path, the stop strikes against the slide, whereby further compression of the auxiliary spring is prevented.

2. The spring assembly according to claim 1, further comprising:
a hydraulic chamber, the slide being formed as a hydraulic piston arranged in the hydraulic chamber;
wherein the hydraulic piston is displaceable away from the second end of the auxiliary spring via hydraulic fluid when the hydraulic fluid is introduced into the hydraulic chamber in order to shorten the predetermined compression path;
wherein the hydraulic piston is displaceable toward the second end of the auxiliary spring when the hydraulic fluid is discharged from the hydraulic chamber in order to extend the predetermined compression path; and
wherein, when the hydraulic chamber is closed-off, the hydraulic piston is supported at the second end of the auxiliary spring via the hydraulic fluid without a change of position.

3. The spring assembly according to claim 1, further comprising an intermediate piece on which the stop is configured, the intermediate piece having a first shoulder on which the first end of the auxiliary spring is supported and a second shoulder on which the master spring is supported.

4. The spring assembly according to claim 2, further comprising an intermediate piece on which the stop is configured, the intermediate piece having a first shoulder on which the first end of the auxiliary spring is supported and a second shoulder on which the master spring is supported.

5. A spring assembly, comprising:
a master spring;
a slide;
a stop;
at least one auxiliary spring, arranged in parallel with the master spring, the auxiliary spring having a first free end displaceable in a compression direction of the spring assembly, the stop being attached to the first free end;
wherein the auxiliary spring has a second end facing away from the first free end with respect to which the slide is settable, a position of the slide being adjustable such that, during compression of the spring assembly, when the first free end overcomes a predetermined compression path, the stop strikes against the slide, whereby the auxiliary spring operates in parallel with the master spring.

6. The spring assembly according to claim 5, further comprising:
a hydraulic chamber, the slide being formed as a hydraulic piston arranged in the hydraulic chamber;
wherein the hydraulic piston is displaceable toward the second end of the auxiliary spring via hydraulic fluid when the hydraulic fluid is introduced into the hydraulic chamber in order to shorten a predetermined compression path;
wherein the hydraulic piston is displaceable away from the second end via the hydraulic fluid being discharged from the hydraulic chamber in order to extend the predetermined compression path; and
wherein, when the hydraulic chamber is closed-off, the hydraulic piston is supported at the second end of the auxiliary spring via the hydraulic fluid without a change of position.

7. The spring assembly according to claim 5, further comprising an intermediate piece on which the stop is configured, the intermediate piece having a first shoulder on which the auxiliary spring is supported at the first end.

8. The spring assembly according to claim 6, further comprising an intermediate piece on which the stop is configured, the intermediate piece having a first shoulder on which the auxiliary spring is supported at the first end.

9. The spring assembly according to claim 7, wherein the intermediate piece has a second shoulder, a contact pressure spring being supported on the second shoulder such that the intermediate piece is attached to the first end of the auxiliary spring.

10. The spring assembly according to claim 8, wherein the intermediate piece has a second shoulder, a contact pressure spring being supported on the second shoulder such that the intermediate piece is attached to the first end of the auxiliary spring.

11. The spring assembly according to claim 2, further comprising:
a hydraulic fluid reservoir;
a hydraulic conduit, the hydraulic conduit connecting the hydraulic fluid reservoir with the hydraulic chamber in a hydraulic-fluid-conducting manner; and
a switching arrangement having check valves, the check valves being operatively configured to block in a direction from the hydraulic chamber to the hydraulic fluid reservoir and in a direction from the hydraulic fluid reservoir to the hydraulic chamber, respectively; and
wherein the switching arrangement further comprises a shut-off device, the shut-off device and check valves being optionally switchable into the hydraulic conduit.

12. The spring assembly according to claim 6, further comprising:
a hydraulic fluid reservoir;
a hydraulic conduit, the hydraulic conduit connecting the hydraulic fluid reservoir with the hydraulic chamber in a hydraulic-fluid-conducting manner; and
a switching arrangement having check valves, the check valves being operatively configured to block in a direction from the hydraulic chamber to the hydraulic fluid reservoir and in a direction from the hydraulic fluid reservoir to the hydraulic chamber, respectively; and
wherein the switching arrangement further comprises a shut-off device, the shut-off device and check valves being optionally switchable into the hydraulic conduit.

13. The spring assembly according to claim 2, further comprising:
a hydraulic fluid reservoir;
a hydraulic conduit connecting the hydraulic chamber with the hydraulic fluid reservoir in a hydraulic-fluid-conducting manner;
wherein the hydraulic fluid reservoir comprises an adjusting piston and an adjusting piston drive, by which the adjusting piston is displaceable such that hydraulic fluid is introducible into the hydraulic chamber via the adjusting piston.

14. The spring assembly according to claim 13, wherein the adjusting piston is freely displaceably arranged in the hydraulic fluid reservoir and the adjusting piston drive is operatively configured as a displaceable adjusting piston stop, which stop limits movement of the adjusting piston when the hydraulic fluid is discharged from the hydraulic chamber; and
wherein the displaceable adjusting piston stop is operatively configured to displace the adjusting piston such that the hydraulic fluid is introducible into the hydraulic chamber.

15. The spring assembly according to claim 6, further comprising:
a hydraulic fluid reservoir;
a hydraulic conduit connecting the hydraulic chamber with the hydraulic fluid reservoir in a hydraulic-fluid-conducting manner;
wherein the hydraulic fluid reservoir comprises an adjusting piston and an adjusting piston drive, by which the adjusting piston is displaceable such that hydraulic fluid is introducible into the hydraulic chamber via the adjusting piston.

16. The spring assembly according to claim 15, wherein the adjusting piston is freely displaceably arranged in the hydraulic fluid reservoir and the adjusting piston drive is operatively configured as a displaceable adjusting piston stop, which stop limits movement of the adjusting piston when the hydraulic fluid is discharged from the hydraulic chamber; and
wherein the displaceable adjusting piston stop is operatively configured to displace the adjusting piston such that the hydraulic fluid is introducible into the hydraulic chamber.

17. The spring assembly according to claim 2, further comprising a hydraulic cylinder forming the hydraulic chamber, the hydraulic cylinder being supported relative to the second end of the auxiliary spring.

18. The spring assembly according to claim 6, further comprising a hydraulic cylinder forming the hydraulic chamber, the hydraulic cylinder being supported relative to the second end of the auxiliary spring.

19. The spring assembly according to claim 14, wherein the hydraulic piston is displaceable by the stop into the hydraulic chamber, when the stop exercises a corresponding force on the hydraulic piston.

20. The spring assembly according to claim 16, wherein the hydraulic piston is displaceable by the stop into the hydraulic chamber, when the stop exercises a corresponding force on the hydraulic piston.

21. A motor vehicle component, comprising:
a spring strut for the motor vehicle, the spring strut comprising a spring assembly comprising:
a master spring;
a slide;
a stop;
at least one auxiliary spring connected in series with the master spring, the auxiliary spring having a first end to which the stop is attached and a second end, facing away from the first end, to which the slide is settable;
wherein a position of the slide is adjustable such that, during the compression of the spring assembly, when the auxiliary spring overcomes a predetermined compression path, the stop strikes against the slide, whereby further compression of the auxiliary spring is prevented.

22. A motor vehicle component, comprising:
a spring strut for the motor vehicle, the spring strut comprising a spring assembly comprising:
a master spring;
a slide;
a stop;
at least one auxiliary spring, arranged in parallel with the master spring, the auxiliary spring having a first free end displaceable in a compression direction of the spring assembly, the stop being attached to the first free end;
wherein the auxiliary spring has a second end facing away from the first free end with respect to which the slide is settable, a position of the slide being adjustable such that, during compression of the spring assembly, when the first free end overcomes a predetermined compression path, the stop strikes against the slide, whereby the auxiliary spring operates in parallel with the master spring.
